(19) United States
(12) Patent Application Publication
(10) Pub. No.: US 2026/0214501 A1
(43) Pub. Date: Jul. 23, 2026

(54) WIRELESS COMMUNICATION DEVICE AND DIFFERENTIATED QUALITY OF SERVICE PROVIDING METHOD

(71) Applicant: WNC Corporation, Hsinchu (TW)

(72) Inventors: Li-Heng SU, Hsinchu (TW); Chuan-Yin CHANG, Hsinchu (TW); Mei-Chien HUANG, Hsinchu (TW); Kai-Han LIU, Hsinchu (TW)

(21) Appl. No.: 19/447,037

(22) Filed: Jan. 13, 2026

(30) Foreign Application Priority Data
Jan. 23, 2025 (TW) 114103167

(51) Int. Cl. H04W 28/02

(52) U.S. Cl. CPC H04W 28/0268; H04W 28/0289

(57) ABSTRACT

A wireless communication device is proposed, and configured to implement a differentiated quality of service providing method. The method includes executing a wireless network detecting module to analyze a plurality of network packets of a plurality of network sessions and classify the network sessions into a plurality of priority levels; executing the wireless network detecting module to detect a wireless network to obtain a network status information, and calculate the network status information according to a congestion detection algorithm to generate a congestion percentage; and executing a wireless network configuring module to establish a differentiated priority list based on the priority levels and configure a plurality of access parameter groups in the differentiated priority list according to the congestion percentage. The wireless communication device forwards the network sessions according to the access parameter groups to provide a quality of service for the network sessions.

### RELATED APPLICATIONS

This application claims priority to Taiwan Application Serial Number 114103167, filed Jan. 23, 2025, which is herein incorporated by reference.

### BACKGROUND

### Technical Field

The present disclosure relates to a communication equipment and a method for providing quality of service. More particularly, the present disclosure relates to a wireless communication device and a differentiated quality of service providing method.

### Description of Related Art

In data communications, a physical network node can be a wireless fidelity data communication equipment (WDCE). When a bottleneck occurs in the ingress or egress direction of the WDCE, multiple network applications running on the WDCE may compete for the limited available network bandwidth. The continual competition results in network congestion and severe application/service degradations caused by network packet delays and/or packet dropouts.

Quality of Service (QoS) is often used for prioritized routing/forwarding of traffic or network packets associated with higher priority applications at a wireless network node to improve the performance of the applications as they traverse through multiple wireless network nodes. However, the existing QoS requires users to specify complicated parameters and priority levels for each of the applications, but most users do not set advanced options for network application services. Furthermore, a service provider may not trust the priority levels set by its users and wish to double check or change them based on his overall network capabilities, conflicting user service requirements, customized service policy/offerings, etc.

With the increasing popularity of major streaming platforms and the growing reliance of modern users on wireless networks, excessive congestion in wireless networks can easily lead to QoS degradation. As a result, even high-priority traffic in the priority queue may receive limited bandwidth and be unable to be forwarded efficiently. In view of this, it can be seen that the current market lacks a communication device and a method for providing QoS that can adapt to extreme wireless network congestion.

### SUMMARY

According to one aspect of the present disclosure, a wireless communication device is configured to receive a plurality of network sessions from a wireless network. The wireless communication device includes a memory and a processor. The memory stores a wireless network detecting module and a wireless network configuring module, and the wireless network detecting module includes a congestion detection algorithm. The processor is connected to the memory and configured to implement a differentiated quality of service providing method. The differentiated quality of service providing method includes executing the wireless network detecting module to analyze a plurality of network packets of the network sessions and classify the network sessions into a plurality of priority levels by the processor; executing the wireless network detecting module to detect the wireless network to obtain a network status information and calculate the network status information according to the congestion detection algorithm to generate a congestion percentage by the processor; and executing the wireless network configuring module to establish a differentiated priority list based on the priority levels and configure a plurality of access parameter groups corresponding to the priority levels in the differentiated priority list according to the congestion percentage by the processor. The wireless communication device forwards the network packets of the network sessions according to the access parameter groups to provide a quality of service for the network sessions.

According to another aspect of the present disclosure, a differentiated quality of service providing method includes receiving a plurality of network sessions from a wireless network by a wireless communication device, wherein the wireless communication device comprises a memory and a processor, the memory stores a wireless network detecting module and a wireless network configuring module, and the wireless network detecting module comprises a congestion detection algorithm; executing the wireless network detecting module to analyze a plurality of network packets of the network sessions and classify the network sessions into a plurality of priority levels by the processor; executing the wireless network detecting module to detect the wireless network to obtain a network status information and calculate the network status information according to the congestion detection algorithm to generate a congestion percentage by the processor; executing the wireless network configuring module to establish a differentiated priority list based on the priority levels and configure a plurality of access parameter groups corresponding to the priority levels in the differentiated priority list according to the congestion percentage by the processor; and forwarding the network packets of the network sessions according to the access parameter groups to provide a quality of service for the network sessions by the wireless communication device.

### BRIEF DESCRIPTION OF THE DRAWINGS

The present disclosure can be more fully understood by reading the following detailed description of the embodiment, with reference made to the accompanying drawings as follows:

FIG. 1 is a schematic view of a wireless communication device receiving a plurality of network sessions from a wireless network according to a first embodiment of the present disclosure.

FIG. 2 is a schematic view of each of the network sessions of FIG. 1.

FIG. 3 is a schematic view of a wireless communication device receiving the network sessions from the wireless network according to a second embodiment of the present disclosure.

FIG. 4 shows a flow chart of a differentiated quality of service providing method according to a third embodiment of the present disclosure.

FIG. 5 is a schematic view of the differentiated quality of service providing method of the present disclosure applied to the wireless communication device.

FIG. 6 is a flow chart of a step of classifying the network sessions into a plurality of priority levels in FIG. 4.

FIG. 7 is a flow chart of a step of generating a congestion percentage in FIG. 4.

FIG. 8 is a flow chart of the differentiated quality of service providing method in some embodiments, in which a differentiated priority list is adjusted based on different network services.

FIG. 9 is a schematic view of a plurality of network sessions and their corresponding plurality of first priority labels and the differentiated priority list of the present disclosure.

FIG. 10 is a schematic view of a plurality of second priority labels and an adjusted priority list of the present disclosure.

FIG. 11 is a schematic view of an arbitration interframe space and a minimum contention window configured by the wireless communication device of the present disclosure when the wireless network is under a low congestion level.

FIG. 12 is a schematic view of a transmission opportunity configured by the wireless communication device of the present disclosure when the wireless network is under the low congestion level.

FIG. 13 is a schematic view of an arbitration interframe space and a minimum contention window configured by the wireless communication device of the present disclosure when the wireless network is under a high congestion level.

FIG. 14 is a schematic view of a transmission opportunity configured by the wireless communication device of the present disclosure when the wireless network is under the high congestion level.

FIG. 15 is a schematic view of the differentiated quality of service providing method of the present disclosure applied to another wireless communication device.

FIG. 16 is a flow chart of a step of forwarding the network packets of the network sessions according to the access parameter groups in FIG. 4.

FIG. 17 is a flow chart of a step of receiving a plurality of network sessions from a wireless network in FIG. 4.

FIG. 18 is a schematic view of the wireless communication device of the present disclosure communicating with another wireless communication device.

FIG. 19 is a flow chart of a step of broadcasting a composite information packet and a step of returning the network sessions of the differentiated quality of service providing method in FIG. 4.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as be “connected” to another element, it can be directly connected to the other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

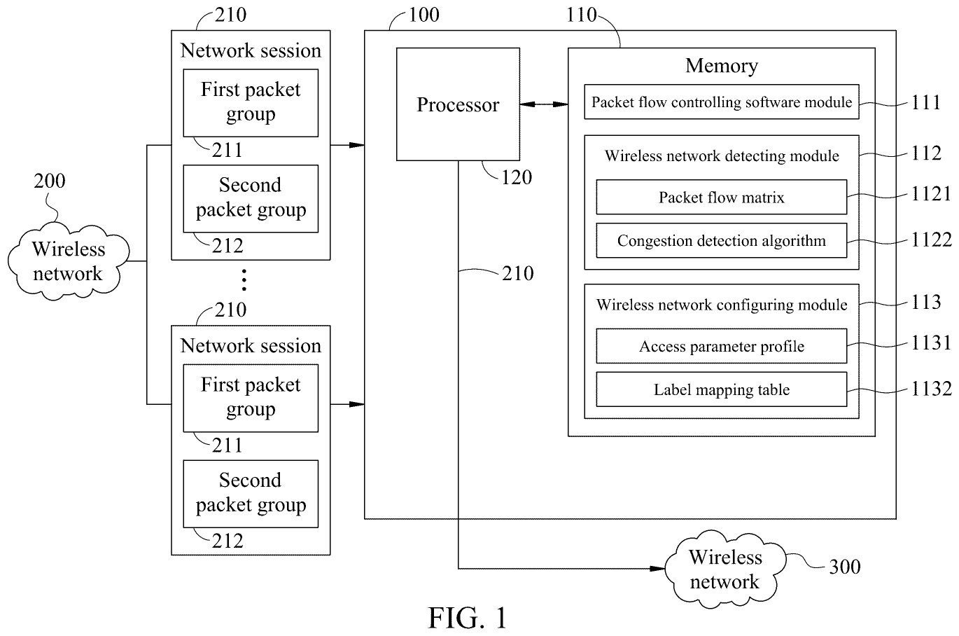

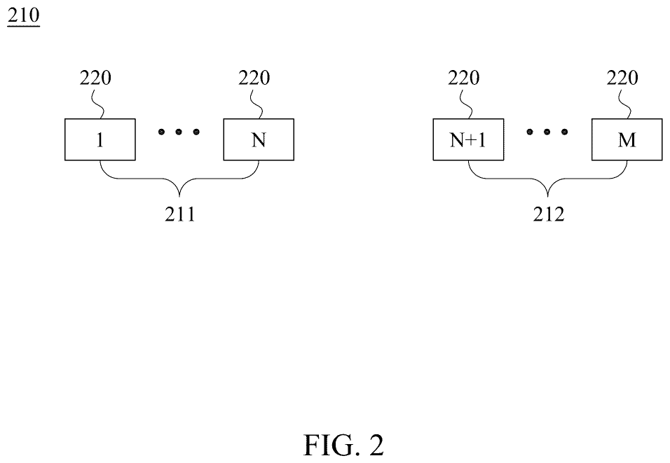

Please refer to FIG. 1 and FIG. 2 together. FIG. 1 is a schematic view of a wireless communication device 100 receiving a plurality of network sessions 210 from a wireless network 200 according to a first embodiment of the present disclosure. FIG. 2 is a schematic view of each of the network sessions 210 of FIG. 1. As shown in FIG. 1 and FIG. 2, the wireless communication device 100 is signally connected between two wireless networks 200, 300 and configured to forward a plurality of network sessions 210 received from the wireless network 200 to the wireless network 300. Each of the network sessions 210 can include a plurality of network packets 220 in a communication service (e.g., sending an email), which can be grouped into a first packet group 211 and a second packet group 212, and a transmission queue of the second packet group 212 is located after a transmission queue of the first packet group 211.

The wireless communication device 100 includes a memory 110 and a processor 120. The memory 110 stores a packet flow controlling module 111, a wireless network detecting module 112, a wireless network configuring module 113 and a plurality of program codes. The packet flow controlling module 111, the wireless network detecting module 112 and the wireless network configuring module 113 can each be software modules constructed through modular programming. In addition, the wireless network detecting module 112 includes a packet flow matrix 1121 and a congestion detection algorithm 1122, while the wireless network configuring module 113 includes a plurality of access parameter profiles 1131 and a label mapping table 1132. The processor 120 is electrically connected to the memory 110 and configured to access the packet flow controlling module 111, the wireless network detecting module 112, the wireless network configuring module 113, and the program codes or instructions to automatically implement a differentiated quality of service providing method proposed in the present disclosure.

In some embodiments, the wireless communication device 100 can be a wireless fidelity data communication equipment (WDCE), which can be but is not limited to, a wireless fidelity access point (Wi-Fi AP), a Wi-Fi Extender, a Wi-Fi router, a Wi-Fi modem, a Wi-Fi Bridge, or a Wi-Fi station that utilizes a long term evolution (LTE) system or a fifth-generation mobile communication technology (5G).

In some embodiments, the memory 110 can be a machine-readable medium, which can be but is not limited to, a random access memory (RAM), a read-only memory (ROM), a compact disc read-only memory (CD-ROM), a flash memory, a hard disk drive, a magnetic tape, a floppy disk, or an optical data storage device.

In some embodiments, the processor 120 can be, but is not limited to, a digital signal processor (DSP), a micro processing unit (MPU), a central processing unit (CPU), or other electronic processors.

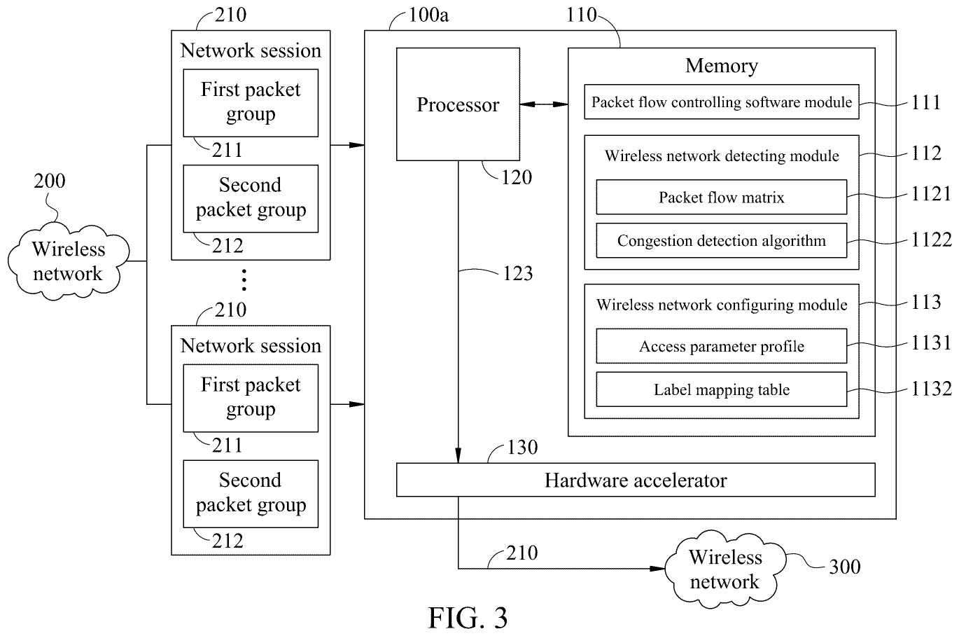

Please refer to FIG. 3. FIG. 3 is a schematic view of a wireless communication device 100a receiving the network sessions 210 from the wireless network 200 according to a second embodiment of the present disclosure. Different from the first embodiment, the wireless communication device 100a can further include a hardware accelerator 130 electrically connected to the processor 120. In some embodiments, the hardware accelerator 130 can be, but is not limited to, a network processing unit (NPU). The processor 120 dynamically monitors the wireless network 200 to calculate a congestion percentage, and configures a plurality of access parameter groups corresponding to different priority levels in a differentiated priority list 123 according to the congestion percentage. The processor 120 executes the wireless network configuring module 113 to write the differentiated priority list 123 to the hardware accelerator 130. The hardware accelerator 130 transmits the network packets 220 of the network sessions 210 according to the differentiated priority list 123. Therefore, the wireless communication device 100a can more quickly forward the network packets 220 of the network sessions 210 to the wireless network 300 by being equipped with the hardware accelerator 130. The following paragraphs, with reference to the figures, provide a detailed description of the operations of each step in the differentiated quality of service providing method of the present disclosure.

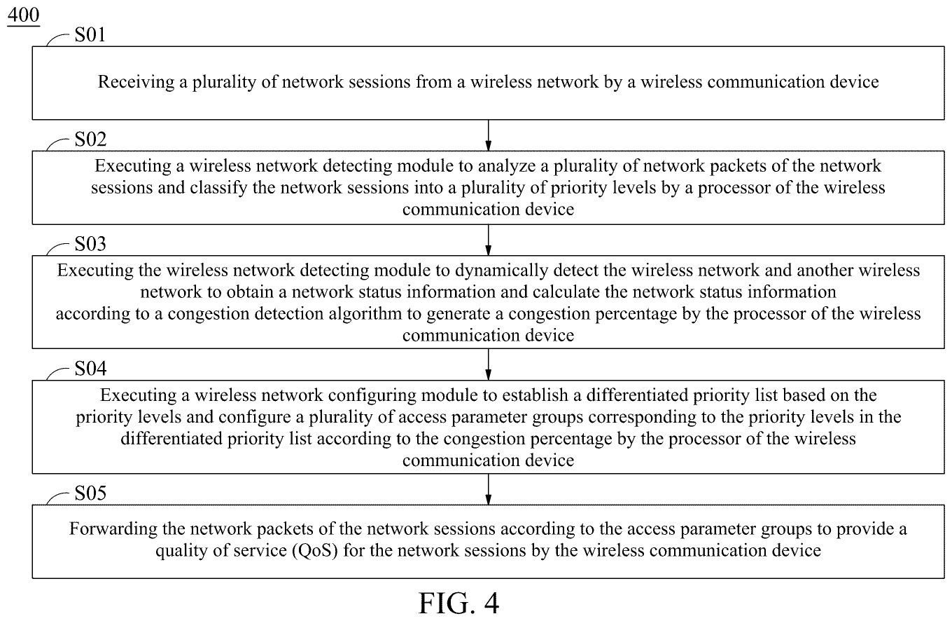

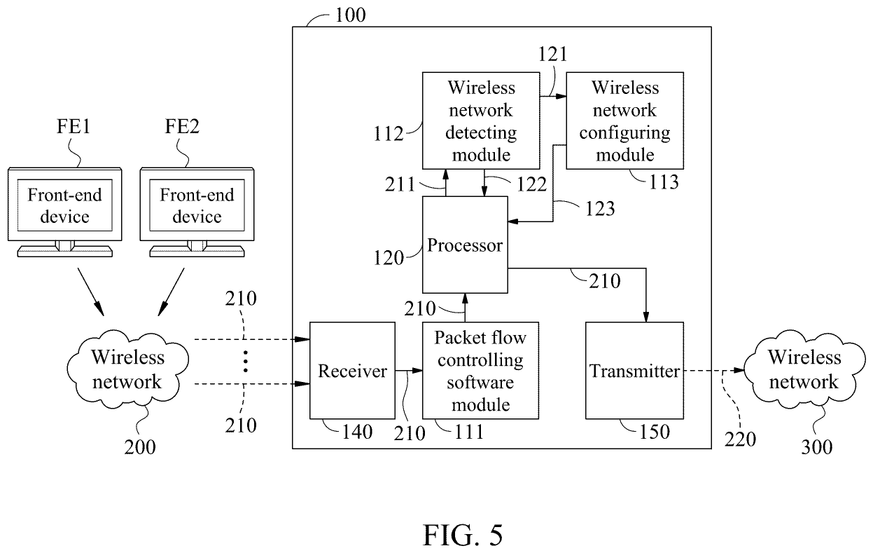

Please refer to FIG. 1, FIG. 2, FIG. 4 and FIG. 5 together. FIG. 4 shows a flow chart of a differentiated quality of service providing method 400 according to a third embodiment of the present disclosure. FIG. 5 is a schematic view of the differentiated quality of service providing method 400 of the present disclosure applied to the wireless communication device 100. The differentiated quality of service providing method 400 can be automatically executed by the wireless communication device 100, and includes the following Steps S01, S02, S03, S04, S05.

Step S01 involves receiving a plurality of network sessions 210 from a wireless network 200 by a wireless communication device 100.

Step S02 involves executing a wireless network detecting module 112 to analyze a plurality of network packets 220 of the network sessions 210 and classify the network sessions 210 into a plurality of priority levels 121 by a processor 120 of the wireless communication device 100.

Step S03 involves executing the wireless network detecting module 112 to dynamically detect the wireless network 200 and another wireless network 300 to obtain a network status information and calculate the network status information according to a congestion detection algorithm 1122 to generate a congestion percentage 122 by the processor 120 of the wireless communication device 100.

Step S04 involves executing a wireless network configuring module 113 to establish a differentiated priority list 123 based on the priority levels 121 and configure a plurality of access parameter groups corresponding to the priority levels 121 in the differentiated priority list 123 according to the congestion percentage 122 by the processor 120 of the wireless communication device 100.

Step S05 involves forwarding the network packets 220 of the network sessions 210 according to the access parameter groups to provide a quality of service (QoS) for the network sessions 210 by the wireless communication device 100.

Thus, the wireless communication device 100, by executing the differentiated quality of service providing method 400, dynamically detects the wireless networks 200, 300 to calculate the current congestion percentage 122 of the wireless networks 200, 300, and configures the access parameter groups corresponding to the different priority levels 121 in the differentiated priority list 123 according to the congestion percentage 122. Therefore, the wireless communication device 100 can forward the network sessions 210 classified into different priority levels 121 according to the differentiated priority list 123, so that those with higher priority levels 121 obtain greater bandwidth, thereby achieving a differentiated QoS effect.

In some embodiments, the wireless communication device 100 can further include a receiver 140 and a transmitter 150. The receiver 140 is configured to respectively receive the network sessions 210 from two front-end devices FE1, FE2 via the wireless network 200, and the transmitter 150 is configured to forward the network sessions 210 to the wireless network 300. Further, Step S01 can include executing the packet flow controlling module 111 to determine whether the first packet group 211 of each of the network sessions 210 has been classified into one of the priority levels 121 to produce a determination result by the processor 120 of the wireless communication device 100. When the first packet group 211 has been classified into the respective priority level 121 (i.e., the determination result is “yes”), the packet flow controlling module 111 transmits the first packet group 211 and the second packet group 212 of each of the network sessions 210 to the processor 120. The processor 120 directly transmits the first packet group 211 and the second packet group 212 to the transmitter 150 and, according to the differentiated priority list 123 configured with the aforementioned access parameter group, controls the transmitter 150 to forward the first packet group 211 and the second packet group 212 to the wireless network 300. Conversely, when the first packet group 211 has not been classified into the respective priority levels 121 (i.e., the determination result is “no”), the packet flow controlling module 111 transmits the first packet group 211 to the processor 120, and then Steps S02, S03, S04, S05 are executed sequentially to classify the first packet group 211 into one of the priority levels 121. The wireless communication device 100 configures the access parameter groups corresponding to the different priority levels 121 in the differentiated priority list 123 according to the congestion percentage 122, thereby providing differentiated QoS.

Specifically, the wireless network detecting module 112 only needs to analyze a certain number of the network packets 220 in order to classify the priority levels of all of the network packets 220 within each network session 210 and determine which priority level 121 each network session 210 belongs to. Through the packet flow controlling module 111, the processor 120 can dynamically adjust the number of packets that need to enter the wireless network detecting module 112 (for example, N network packets, i.e., the first packet group 211 in FIG. 2). Therefore, the processor 120 does not need to execute the wireless network detecting module 112 for every network packet 220 in each network session 210. In other words, the wireless network detecting module 112 does not need to analyze the N+1th to Mth network packets 220 (i.e., the second packet group 212), and yet the processor 120 can still determine which priority level 121 the subsequent queued network packets 220 belong to.

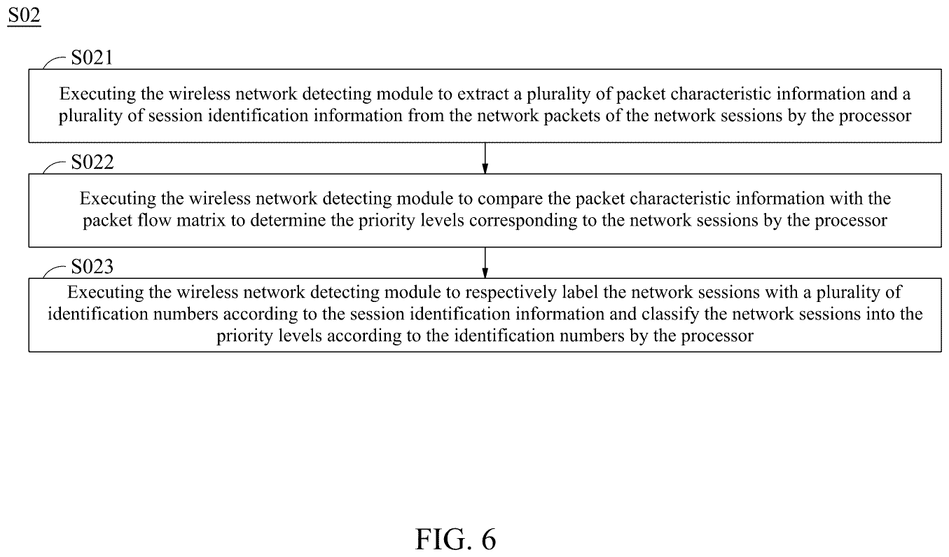

Please refer to FIG. 6. FIG. 6 is a flow chart of Step S02 of classifying the network sessions 210 into the priority levels 121 in FIG. 4. In some embodiments, Step S02 can include Steps S021, S022, S023.

Step S021 involves executing the wireless network detecting module 112 to extract a plurality of packet characteristic information and a plurality of session identification information from the network packets 220 of the network sessions 210 by the processor 120. In Step S021, the wireless network detecting module 112 extracts one or more headers from one or more network packets 220 in the first packet group 211 of each of the network sessions 210. The header can include the packet characteristic information corresponding to the network packet 220 and the session identification information corresponding to the network session 210.

Step S022 involves executing the wireless network detecting module 112 to compare the packet characteristic information with the packet flow matrix 1121 to determine the priority levels 121 corresponding to the network sessions 210 by the processor 120. In Step S022, the packet characteristic information in each of the network sessions 210 can include at least one of a packet length information and a packet time information. The packet length information includes a packet length of the network packet 220, and the packet time information includes an inter-packet timestamp between the current network packet 220 and the previous network packet 220. When the wireless communication device 100 receives the network session 210, the processor 120 records a timestamp of each of the network packets 220 and a difference (i.e., the inter-packet timestamp) between two timestamps of the two network packets 220 transmitted in sequence.

In addition, the packet flow matrix 1121 can be constructed by normalizing a plurality of packet characteristic lookup tables, and each of packet characteristic lookup tables includes fields for the packet length, the inter-packet timestamp and an application type. Please refer to Tables 1 and 2, which provide two examples of two packet characteristic lookup tables in the packet flow matrix 1121, respectively, but the present disclosure is not limited thereto.

TABLE 1

| | packet | inter-packet | |
|---|---|---|---|
| | length | timestamp | application |
| packet | (bytes) | (ms) | type |
| 1 | 76 | 0 | network stream type |
| 2 | 128 | 101 | network stream type |
| 3 | 85 | 96 | network stream type |
| . . . | . . . | . . . | network stream type |
| 100 | 96 | 120 | network stream type |

TABLE 2

| | packet | inter-packet | |
|---|---|---|---|
| | length | timestamp | application |
| packet | (bytes) | (ms) | type |
| 1 | 1400 | 0 | network download type |
| 2 | 1358 | 603 | network download type |
| 3 | 1268 | 652 | network download type |
| . . . | . . . | . . . | network download type |
| 200 | 1536 | 785 | network download type |

In Table 1, the packet characteristic lookup table lists the packet lengths, the inter-packet timestamps and the application types corresponding to a packet flow (i.e., the packets 1 to 100). In Table 2, the packet characteristic lookup table lists the packet lengths, the inter-packet timestamps and the application types corresponding to another packet flow (i.e., the packets 1 to 200).

In some embodiments, the wireless network detecting module 112 can further include a machine learning algorithm (not shown), which can be but is not limited to, a clustering algorithm and a Bayesian algorithm. The wireless network detecting module 112 cross-compares the packet characteristic information in the header with the packet characteristic lookup tables in the packet flow matrix 1121 according to the machine learning algorithm. In other words, the wireless network detecting module 112 can search the packet flow matrix 1121 for the packet characteristic lookup table that corresponds to the packet characteristic information, thereby determining the application type of each of the network sessions 210.

In some embodiments, the wireless network detection module 112 can further include an application type lookup table (not shown). After determining the application type of each of the network sessions 210, the wireless network detecting module 112 searches the application type lookup table for the priority level 121 corresponding to the application type of each of the network sessions 210. Please refer to Table 3, which provides examples of the priority levels 121 corresponding to different application types in the application type lookup table, but the present disclosure is not limited thereto.

TABLE 3

| application type | priority level |
|---|---|
| network voice type | 1 |
| network stream type | 2 |
| network basic type | 3 |
| network download type | 4 |

In Table 3, the application types include a network voice type (i.e., Voice (VO)), a network stream type (i.e., Video (VI)), a network basic type (i.e., Best Effort (BE)) and a network download type (i.e., Background (BK)), and their corresponding priority levels 121 are 1 to 4. For example, the packet characteristic information extracted by the wireless network detecting module 112 from one of the network sessions 210 can include a packet length of 1435 bytes and an inter-packet timestamp of 300 ms. Based on the Bayesian algorithm, the wireless network detecting module 112 searches the packet flow matrix 1121 for the packet characteristic lookup table (i.e., Table 2) that corresponds to or is similar to the aforementioned packet characteristic information, and infers that the application type of the network session 210 is the network download type (BK). The wireless network detecting module 112 retrieves from the application type lookup table that the priority level 121 corresponding to the network download type (BK) is level 4, and the priority levels 121 of other network sessions 210 are determined similarly. Accordingly, by executing the differentiated quality of service providing method 400, the wireless communication device 100 can not only automatically identify the application type to which each of the network sessions 210 belongs, but also determine the priority levels 121 corresponding to different application types through the application type lookup table.

Step S023 involves executing the wireless network detecting module 112 to respectively label the network sessions 210 with a plurality of identification numbers according to the session identification information and classify the network sessions 210 into the priority levels 121 according to the identification numbers by the processor 120, wherein the identification numbers are different from each other. In Step S023, the session identification information corresponding to each of the network sessions 210 can include a communication protocol, a source address, a source port, a destination address and a destination port.

Please refer to Table 4. Table 4 provides an example of the session identification information of the network sessions 210 of the front-end devices FE1, FE2, but the present disclosure is not limited thereto.

TABLE 4

| | identification | communication | source | destination | source | destination |
|---|---|---|---|---|---|---|
| | number | protocol | address | address | port | port |
| network | 1 | UDP | 192.168.0.33 | 23.4.5.22 | 31234 | 21 |
| session | | | | | | |
| network | 2 | TCP | 192.168.0.67 | 134.42.3.3 | 23234 | 7852 |
| session | | | | | | |

When the wireless communication device 100 initially receives two network sessions 210 from the front-end devices FE1, FE2, the processor 120 executes the wireless network detecting module 112 to label two first packet groups 211 in the two network sessions 210 as the identification number (1) and the identification number (2), respectively. As shown in Table 4, the wireless network detecting module 112, based on the distinct session identity information in the headers, can label the two network sessions 210 from the front-end devices FE1, FE2 as the identification number (1) and the identification number (2), respectively, and classify the two network sessions 210 into different priority levels 121 according to the identification number (1) and the identification number (2), for example, into two among priority levels 1 to 4, or into a high priority level and a low priority level.

Furthermore, based on the source address (i.e., 192.168.0.33) in Table 4, the processor 120 can determine that the network session 210 corresponding to the identification number (1) is provided by the front-end device FE1, and based on another source address (i.e., 192.168.0.67) in Table 4, the processor 120 can determine that the network session 210 corresponding to the identification number (2) is provided by the front-end device FE2. Therefore, the wireless communication device 100 can identify, through different identification numbers and source addresses, which of the front-end device FE1 or the front-end device FE2 the network session 210 received from the wireless network 200 originates from.

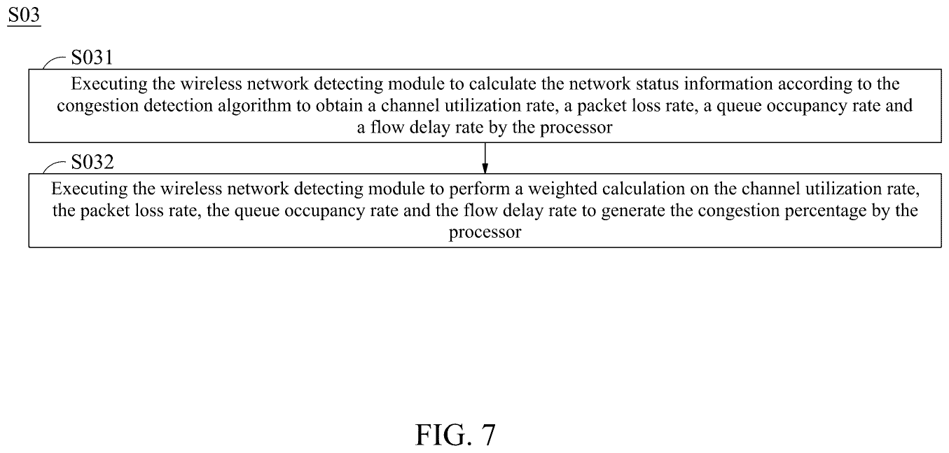

Please refer to FIG. 7. FIG. 7 is a flow chart of Step S03 of generating the congestion percentage 122 in FIG. 4. In some embodiments, Step S03 can include Steps S031, S032.

Step S031 involves executing the wireless network detecting module 112 to calculate the network status information according to the congestion detection algorithm 1122 to obtain a channel utilization rate, a packet loss rate, a queue occupancy rate and a flow delay rate by the processor 120. Specifically, the network status information includes a plurality of information sets corresponding to the current status of the wireless network 200, which are hereinafter referred to as a first information set, a second information set, a third information set and a fourth information set.

The first information set can include a total channel available time and a channel usage time. The total channel available time represents the total available time of a channel in the wireless network 200 (e.g., 1000 ms), and the channel usage time represents the total time during which the channel in the wireless network 200 is utilized (e.g., 300 ms).

The second information set can include a total number of packet transmissions and a number of packet losses. The total number of packet transmissions represents the total number of the network packets 220 transmitted via the wireless network 200 to the wireless communication device 100 (e.g., 10,000 packets), while the number of packet losses (e.g., 200 packets) represents the difference between the foregoing total number and the number of packets actually received by the wireless communication device 100.

The third information set can include a total number of queue transmissions and a cumulative number of queue occupations. The total number of queue transmissions represents the total number of times (e.g., 1,000 times) that the network sessions 210 are forwarded by the wireless communication device 100 to the wireless network 300. The cumulative number of queue occupations represents the total number of times (e.g., 200 times), accumulated, that when the processor 120 forwards any one of the network sessions 210, the transmission queue has already been occupied by another network session 210 having the same priority level 121.

The fourth information set can include a maximum historical round trip time and a current maximum round trip time. The maximum historical round trip time represents the maximum value of round trip time (RTT) in the history records stored in the memory 110. The current maximum round trip time represents the maximum value of the RTT of the wireless networks 200, 300 dynamically detected by the processor 120 over a period of time.

In step S031, the processor 120 executes the wireless network detecting module 112 to generate a channel utilization rate (e.g., 30%) by dividing the channel usage time by the total channel available time, to generate a packet loss rate (e.g., 2%) by dividing the number of packet losses by the total number of packet transmissions, to generate a queue occupancy rate (e.g., 20%) by dividing the cumulative number of queue occupations by the total number of queue transmissions, and to generate a flow delay rate (e.g., 2%) by dividing the current maximum round trip time by the maximum historical round trip time.

Step S032 involves executing the wireless network detecting module 112 to perform a weighted calculation on the channel utilization rate, the packet loss rate, the queue occupancy rate and the flow delay rate to generate the congestion percentage 122 by the processor 120. Please refer to Table 5. Table 5 provides examples of the congestion percentages 122 in different network environments with and without QoS enabled, but the present disclosure is not limited thereto.

TABLE 5

| | channel | packet | queue | flow | |
|---|---|---|---|---|---|
| network | utilization | loss | occupancy | delay | congestion |
| environment | rate | rate | rate | rate | percentage |
| Ethernet with QoS | N/A | 0% | 20% | 50% | 35% |
| (TCP protocol) | | | | | |
| wireless network | 40% | 50% | 50% | N/A | 45% |
| with QoS (UDP | | | | | |
| protocol) | | | | | |
| QoS not enabled | N/A | N/A | N/A | 80% | 80% |

In Step S032, the processor 120 utilizes a first weight, a second weight, a third weight and a fourth weight to perform the weighted calculation on the channel utilization rate, the packet loss rate, the queue occupancy rate and the flow delay rate to obtain the congestion percentage 122, and the weighted calculation can conform to the following equation (1):

$$CP = {w}_{1} \cdot CU + {w}_{2} \cdot DR + {w}_{3} \cdot OT + {w}_{4} \cdot FL . \qquad ( 1 )$$

In the equation (1), CP is the congestion percentage 122, w₁ is the first weight, CU is the channel utilization rate, w₂ is the second weight, DR is the packet loss rate, w₃ is the third weight, OT is the queue occupancy rate, w₄ is the fourth weight, FL is the flow delay rate, and w₁+w₂+w₃+w₄=1.

As shown in Table 5, when transmission control protocol (TCP) of the Ethernet is congested, the first weight (w₁), the second weight (w₂), the third weight (w₃) and the fourth weight (w₄) can be 0, 0, 0.5, and 0.5, respectively. The processor 120 can calculate the congestion percentage 122 of the Ethernet as 35% based on the equation (1). When a network is not congested (QoS is not enabled), the first weight (w₁), the second weight (w₂), the third weight (w₃) and the fourth weight (w₄) can be 0, 0, 0, and 1, respectively. The processor 120 can calculate the congestion percentage 122 of the network not congested as 80% based on the equation (1). When user datagram protocol (UDP) in the wireless networks 200, 300 is congested, the first weight (w₁), the second weight (w₂), the third weight (w₃) and the fourth weight (w₄) can be 0.5, 0.25, 0.25, and 0, respectively. The processor 120 can calculate the congestion percentage 122 of the wireless networks 200, 300 as 45% based on the equation (1).

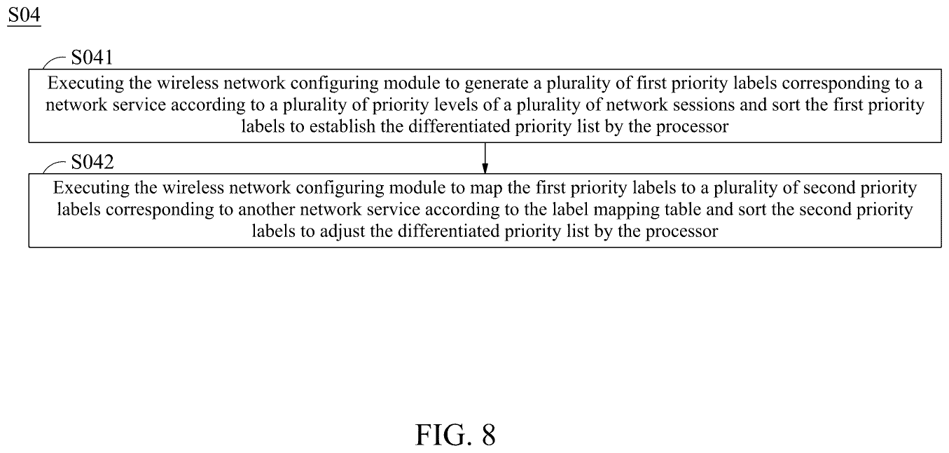

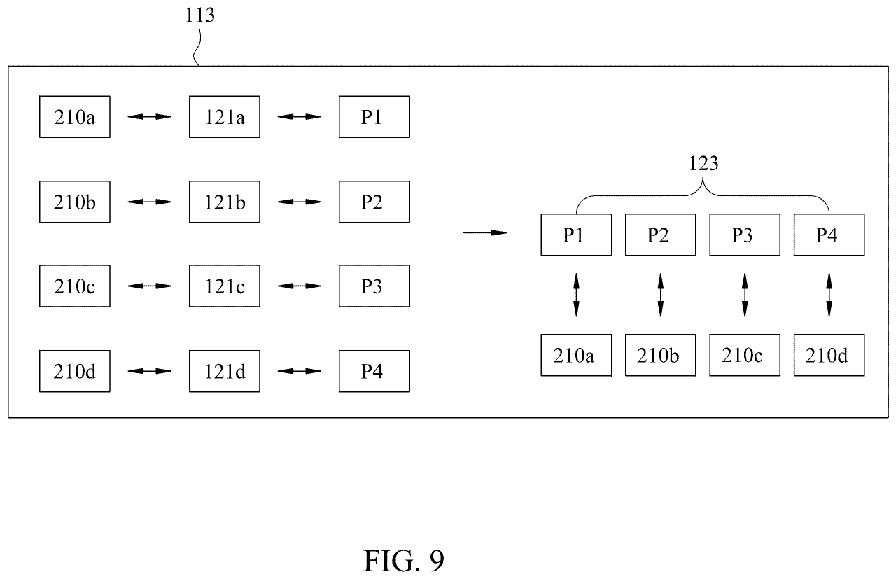

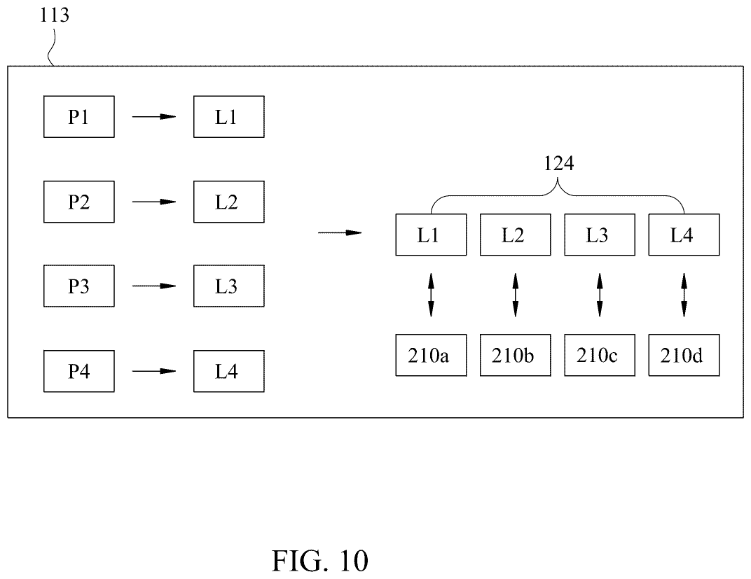

Please refer to FIG. 8, FIG. 9 and FIG. 10 together. FIG. 8 is a flow chart of the differentiated quality of service providing method 400 in some embodiments, in which differentiated priority list 123 is adjusted based on different network services. FIG. 9 is a schematic view of a plurality of network sessions 210a, 210b, 210c, 210d and their corresponding plurality of first priority labels P1, P2, P3, P4 and the differentiated priority list 123 of the present disclosure. FIG. 10 is a schematic view of a plurality of second priority labels L1, L2, L3, L4 and an adjusted priority list 124 of the present disclosure.

In some embodiments, if the network service provided by the wireless network 200 is different from the network service provided by the wireless network 300 in FIG. 5, Step S04 of the differentiated quality of service providing method 400 of the present disclosure can include Steps S041, S042. Step S041 involves executing the wireless network configuring module 113 to generate a plurality of first priority labels P1, P2, P3, P4 corresponding to a network service (e.g. Wi-Fi, i.e., the wireless network 200) according to a plurality of priority levels 121a, 121b, 121c, 121d of a plurality of network sessions 210a, 210b, 210c, 210d and sort the first priority labels P1, P2, P3, P4 to establish the differentiated priority list 123 by the processor 120.

For example, the front-end devices FE1, FE2 transmit the network sessions 210a, 210b, 210c, 210d to the wireless communication device 100 via the wireless network 200. The wireless communication device 100 utilizes the wireless network detecting module 112 to classify the network sessions 210a, 210b, 210c, 210d into four priority levels 121a, 121b, 121c, 121d (e.g., level 1, level 2, level 3 and level 4). The wireless network configuring module 113 matches the priority levels 121a, 121b, 121c, 121d to the first priority labels P1, P2, P3, P4, respectively. In detail, the wireless network configuring module 113 sets the first priority label P1 to match the priority level 121a of level 1 (i.e., network voice type), sets the first priority label P2 to match the priority level 121b of level 2 (i.e., network stream type), sets the first priority label P3 to match the priority level 121c of level 3 (i.e., network basic type), and sets the first priority label P4 to match the priority level 121d of level 4 (i.e., network download type). Subsequently, the wireless network configuring module 113 sets QoS rules for the first priority labels P1, P2, P3, P4, and sorts the first priority labels P1, P2, P3, P4 to generate the differentiated priority list 123. In the differentiated priority list 123, the priority order of the transmission queues is the first priority label P1>the first priority label P2>the first priority label P3>the first priority label P4. Therefore, the processor 120 controls the transmitter 150 to sequentially transmit the network sessions 210a, 210b, 210c, 210d based on the first priority labels P1, P2, P3, P4 in the differentiated priority list 123.

Step S042 executing the wireless network configuring module 113 to map the first priority labels P1, P2, P3, P4 to a plurality of second priority labels L1, L2, L3, L4 corresponding to another network service (e.g., the Ethernet) according to the label mapping table 1132 and sort the second priority labels L1, L2, L3, L4 to adjust the differentiated priority list 123 by the processor 120. Please refer to Table 6. Table 6 provides an example of multiple network services in the label mapping table 1132, but the present disclosure is not limited thereto.

TABLE 6

| | network service | | | | |
|---|---|---|---|---|---|
| | | | | routing/ | wireless |
| | | network | VLAN | forwarding | network |
| | Ethernet | slicing | (ID/Priority) | service | (Wi-Fi) |
| priority | Low | mission- | 100/1 | routing | WMM |
| level | | critical | | WAN1 | high |
| | | slicing | | | |
| | high | latency- | 200/7 | forwarding | WMM |
| | | sensitive | | | low |
| | | slicing | | | |

For example, the first priority labels P1, P4 in FIG. 10 respectively correspond to Wi-Fi Multimedia (WMM) High and WMM Low of the wireless network 200 in Table 6. Based on Table 6, the wireless network configuring module 113 can map the WMM High of the wireless network 200 corresponding to the first priority label P1 to any one of the priority level (mission) of the network slicing, the priority level (100/1) of the Virtual Local Area Network (VLAN), the routing WAN1 of the routing/forwarding service and the Ethernet priority level (Low) of the wireless network, thereby forming the second priority label L1. The mapping relationship between the first priority label P4 and the second priority label L4 can be deduced in the same manner, and will not be described again herein. Hence, when the wireless network 300 located at the back-end of the wireless communication device 100 is signally connected to a back-end equipment of other network services (e.g., Ethernet), the wireless communication device 100 can still sort the second priority labels L1, L2, L3, L4 to generate the adjusted priority list 124 so as to set QoS of other network services, thereby realizing a transmission mechanism of queuing/dequeuing/forwarding/routing with different priority levels among multiple network services.

In some embodiments, the memory 110 can further store a plurality of preset access parameter groups. Therefore, when the differentiated priority list 123 is created initially, the wireless network configuring module 113 can read the preset access parameter groups from the memory 110 and match them to different application types or priority levels in the differentiated priority list 123. Each access parameter group can include a plurality of enhanced distributed channel access (EDCA) parameters. Specifically, the EDCA parameters include an arbitration interframe space (AIFS), a minimum contention window (CWmin), a maximum contention window (CWmax), and a transmission opportunity (TXOP).

Please refer to Table 7. Table 7 provides an example of the preset access parameter groups, but the present disclosure is not limited thereto.

TABLE 7

| application type | AIFS | CWmin | CWmax | TXOP |
|---|---|---|---|---|
| network voice | 2 ms | 3 ms | 7 ms | 1.5 ms |
| type (VO) | | | | |
| network stream | 2 ms | 7 ms | 15 ms | 3 ms |
| type (VI) | | | | |
| network basic | 3 ms | 15 ms | 31 ms | 0.8 ms |
| type (BE) | | | | |
| network download | 7 ms | 15 ms | 127 ms | 0 ms |
| type (BK) | | | | |

As shown in Table 7, the processor 120 can configure different EDCA parameters for different application types in the differentiated priority list 123 through the wireless network configuring module 113, so that application types with high real-time requirements or performing critical tasks (such as network voice type belonging to level 1) are given higher priority in utilizing network bandwidth.

Furthermore, the access parameter profiles 1131 of the wireless network configuring module 113 can correspond to a plurality of congestion levels. Please refer to Table 8 and Table 9. Table 8 provides an example of the correspondence between the congestion percentage 122 and the congestion level, and Table 9 provides an example of the correspondence between the congestion level and the access parameter profile 1131, but the present disclosure is not limited thereto.

TABLE 8

| congestion percentage | congestion level |
|---|---|
| 0%~5% | Low |
| 5%~80% | Medium |
| 80%~100% | High |

TABLE 9

| congestion level | access parameter profile |
|---|---|
| Low | EDCA1 |
| Medium | EDCA2 |
| High | EDCA3 |

As shown in Table 8 and Table 9, the congestion levels can include a low level, a medium level and a high level. Different congestion levels respectively correspond to different percentage ranges and respectively correspond to different access parameter profiles 1131.

In Step S04, the wireless network configuring module 113 configures the access parameter groups corresponding to the priority levels 121a, 121b, 121c, 121d in the differentiated priority list 123 according to the congestion percentage 122 calculated by the wireless network detecting module 112. In some embodiments, Step S04 can further include executing the wireless network configuring module 113 to compare the congestion percentage with three different congestion levels based on Table 8 and Table 9 to select one of the access parameter profiles 1131, and adjust the access parameter groups corresponding to the priority levels 121a, 121b, 121c, 121d in the differentiated priority list 123 based on the one of the access parameter profiles 1131 by the processor 120, thereby adjusting the preset access parameter groups.

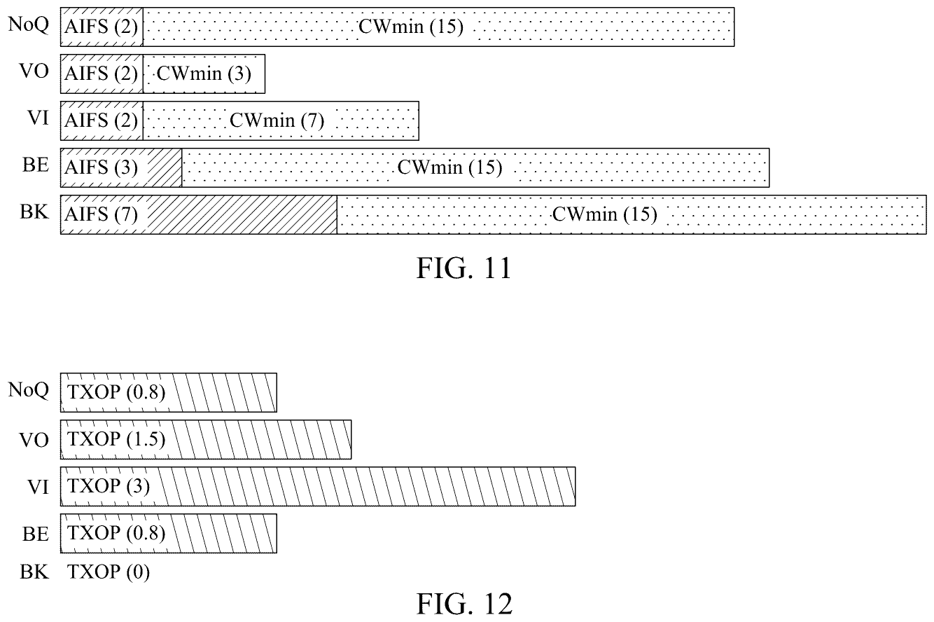

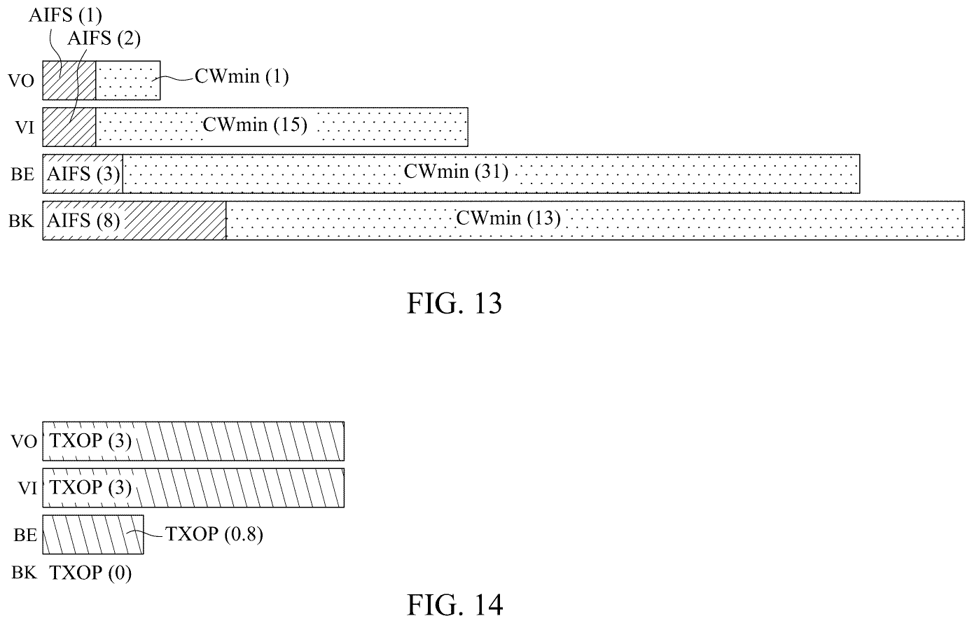

Please refer to FIG. 11, FIG. 12, FIG. 13 and FIG. 14. FIG. 11 is a schematic view of an arbitration interframe space AIFS and a minimum contention window CWmin configured by the wireless communication device 100 of the present disclosure when the wireless network 200 is under a low congestion level. FIG. 12 is a schematic view of a transmission opportunity TXOP configured by the wireless communication device 100 of the present disclosure when the wireless network 200 is under the low congestion level. FIG. 13 is a schematic view of an arbitration interframe space AIFS and a minimum contention window CWmin configured by the wireless communication device 100 of the present disclosure when the wireless network 200 is under a high congestion level. FIG. 14 is a schematic view of a transmission opportunity TXOP configured by the wireless communication device 100 of the present disclosure when the wireless network 200 is under the high congestion level.

Please refer to Table 10, Table 11 and Table 12. Table 10 provides an example of the access parameter profile 1131 corresponding to the low congestion level (i.e., EDCA1 in Table 9), Table 11 provides an example of the access parameter profile 1131 corresponding to the medium congestion level (i.e., EDCA2 in Table 9), and Table 12 provides an example of the access parameter profile 1131 corresponding to the high congestion level (EDCA3 in Table 9), but the present disclosure is not limited thereto.

TABLE 10

| application type | AIFS | CWmin | CWmax | TXOP |
|---|---|---|---|---|
| network voice | +0 ms | +0 ms | +0 ms | +0 ms |
| type (VO) | | | | |
| network stream | +0 ms | +0 ms | +0 ms | +0 ms |
| type (VI) | | | | |
| network basic | +0 ms | +0 ms | +0 ms | +0 ms |
| type (BE) | | | | |
| network download | +0 ms | +0 ms | +0 ms | +0 ms |
| type (BK) | | | | |

TABLE 11

| application type | AIFS | CWmin | CWmax | TXOP |
|---|---|---|---|---|
| network voice | −1 ms | +0 ms | −4 ms | +1.5 ms |
| type (VO) | | | | |
| network stream | +0 ms | +0 ms | +0 ms | +0 ms |
| type (VI) | | | | |
| network basic | +0 ms | +0 ms | +0 ms | +0 ms |
| type (BE) | | | | |
| network download | +8 ms | +16 ms | +896 ms | +0 ms |
| type (BK) | | | | |

TABLE 12

| application type | AIFS | CWmin | CWmax | TXOP |
|---|---|---|---|---|
| network voice | −1 ms | +0 ms | −4 ms | +1.5 ms |
| type (VO) | | | | |
| network stream | +1 ms | +8 ms | +16 ms | +0 ms |
| type (VI) | | | | |
| network basic | +4 ms | +16 ms | +96 ms | +0 ms |
| type (BE) | | | | |
| network download | +8 ms | +16 ms | +896 ms | +0 ms |
| type (BK) | | | | |

As shown in FIG. 11 and FIG. 12, a non-quality of service NoQ represents that the network packet 220 is not classified into a specific priority level in the transmission queue, and an arbitration interframe space AIFS, a minimum contention window CWmin and a transmission opportunity (TXOP) of the non-quality of service NoQ can be 2 ms, 15 ms, and 0.8 ms, respectively.

When the differentiated priority list 123 is created initially, the wireless network configuring module 113 matches the preset access parameter groups in the memory 110 to the priority levels 121 corresponding to a network voice type VO, a network stream type VI, a network basic type BE and a network download type BK in the differentiated priority list 123. If the processor 120 detects, through the wireless network detecting module 112, that the current congestion percentage 122 of the wireless network 200 is 3% (i.e., the low congestion level), the processor 120 selects the access parameter profile 1131 of Table 10 and adjusts the preset access parameter groups based on the access parameter profile 1131 of Table 10. In other words, the arbitration interframe space AIFS corresponding to the network voice type VO is 2 ms (i.e., 2 ms+0 ms), the minimum contention window CWmin is 3 ms (i.e., 3 ms+0 ms), and the transmission opportunity TXOP is 1.5 ms (i.e., 1.5 ms+0 ms). The network stream type VI, the network basic type BE and the network download type BK, are deduced in the same manner, and will not be described again herein.

As shown in FIG. 13 and FIG. 14, if the processor 120 detects, through the wireless network detecting module 112, that the current congestion percentage 122 of the wireless network 200 is 85% (i.e., the high congestion level), the processor 120 selects the access parameter profile 1131 of Table 12 and adjusts the preset access parameter groups based on the access parameter profile 1131 of Table 12. In other words, the arbitration interframe space AIFS corresponding to the network voice type VO is 1 ms (i.e., 2 ms-1 ms), the minimum contention window CWmin is 3 ms (i.e., 3 ms+0 ms), and the transmission opportunity TXOP is 3 ms (i.e., 1.5 ms+1.5 ms). The network stream type VI, the network basic type BE and the network download type BK, are deduced in the same manner, and will not be described again herein.

Accordingly, the wireless communication device 100 can send the network packets 220 to the corresponding transmission queue based on the designated priority labels, and optimize the transmission of high-priority queues via EDCA parameters. Therefore, when the congestion level of the wireless networks 200, 300 is too high, the wireless communication device 100 can increase the differences among the priority levels 121 in the transmission queues by utilizing the access parameter profiles 1131 corresponding to different congestion levels, thereby allowing queues with higher priority levels 121 to obtain greater network bandwidth.

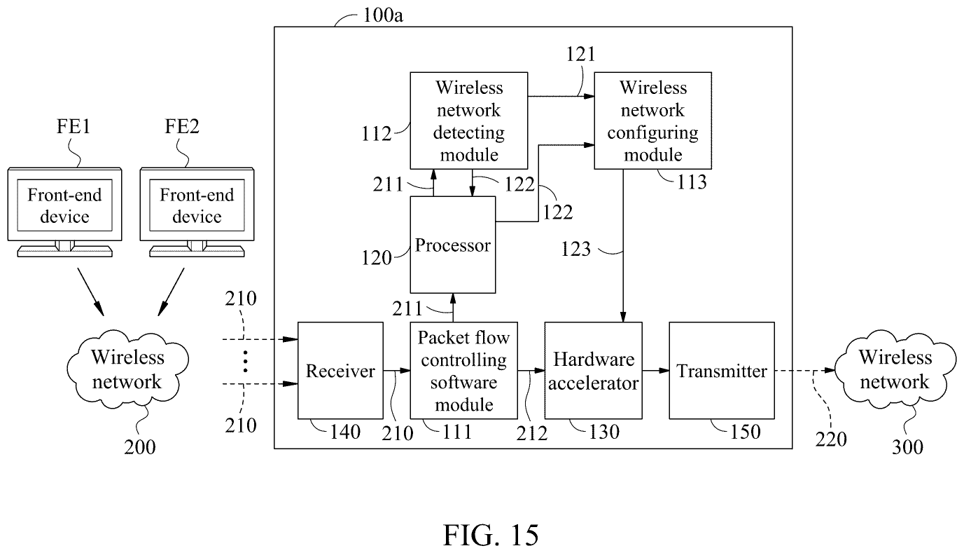

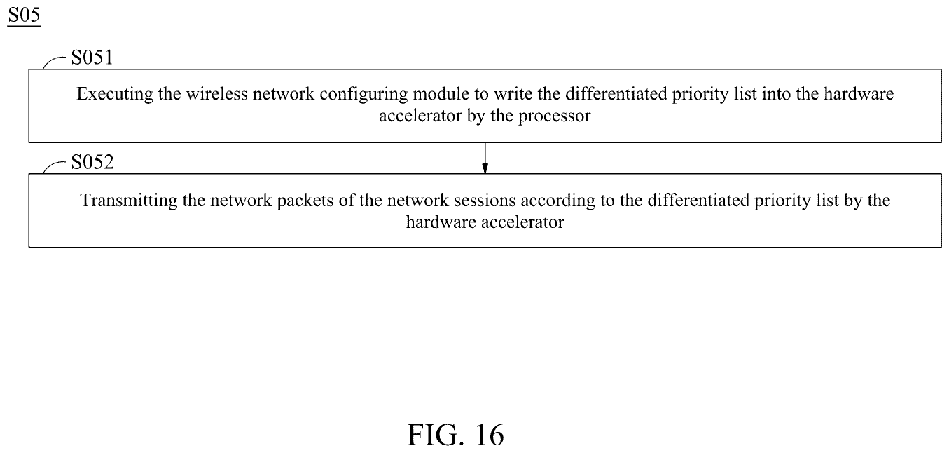

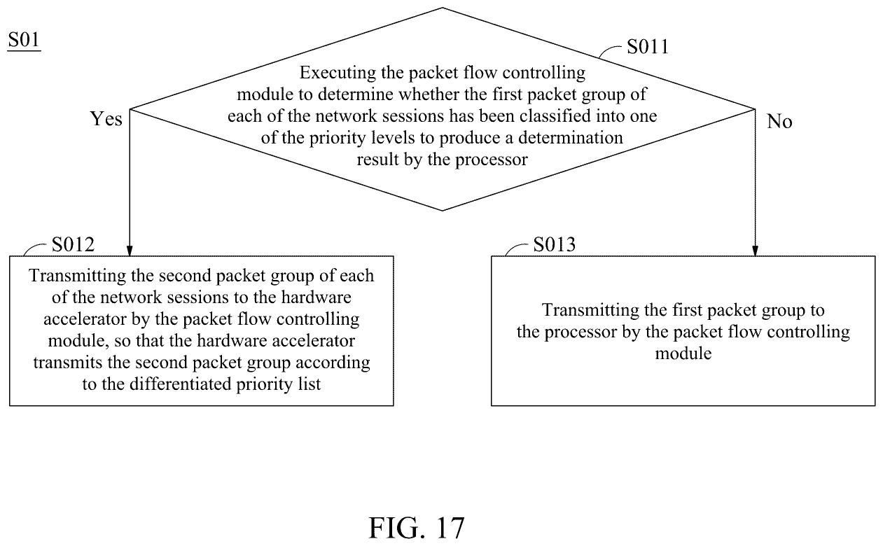

Please refer to FIG. 15, FIG. 16 and FIG. 17. FIG. 15 is a schematic view of the differentiated quality of service providing method 400 of the present disclosure applied to another wireless communication device 100a. FIG. 16 is a flow chart of Step S05 of forwarding the network packets 220 of the network sessions 210 according to the access parameter groups in FIG. 4. FIG. 17 is a flow chart of Step S01 of receiving the network sessions 210 from the wireless network 200 in FIG. 4.

In some embodiments, Step S05 can include Steps S051, S052. Step S051 involves executing the wireless network configuring module 113 to write the differentiated priority list 123 into the hardware accelerator 130 by the processor 120. Step S052 involves transmitting the network packets 220 of the network sessions 210 according to the differentiated priority list 123 by the hardware accelerator 130. The access parameter groups in the differentiated priority list 123 has been configured or adjusted by the processor 120 executing the wireless network configuring module 113 according to the congestion percentage 122.

In addition, different from the differentiated quality of service providing method 400 applied to the wireless communication device 100, Step S01 can further include Steps S011, S012, S013. Step S011 involves executing the packet flow controlling module 111 to determine whether the first packet group 211 of each of the network sessions 210 has been classified into one of the priority levels 121 to produce a determination result by the processor 120. When the first packet group 211 has been classified into the respective priority level 121 (i.e., the determination result is “yes”), Step S012 is executed. Step S012 involves transmitting the second packet group 212 of each of the network sessions 210 to the hardware accelerator 130 by the packet flow controlling module 111, so that the hardware accelerator 130 transmits the second packet group 212 according to the differentiated priority list 123. Conversely, when the first packet group 211 has not been classified into the respective priority levels 121 (i.e., the determination result is “no”), Step S013 is executed. Step S013 involves transmitting the first packet group 211 to the processor 120 by the packet flow controlling module 111, and then Steps S02, S03, S04 are executed sequentially to establish the differentiated priority list 123.

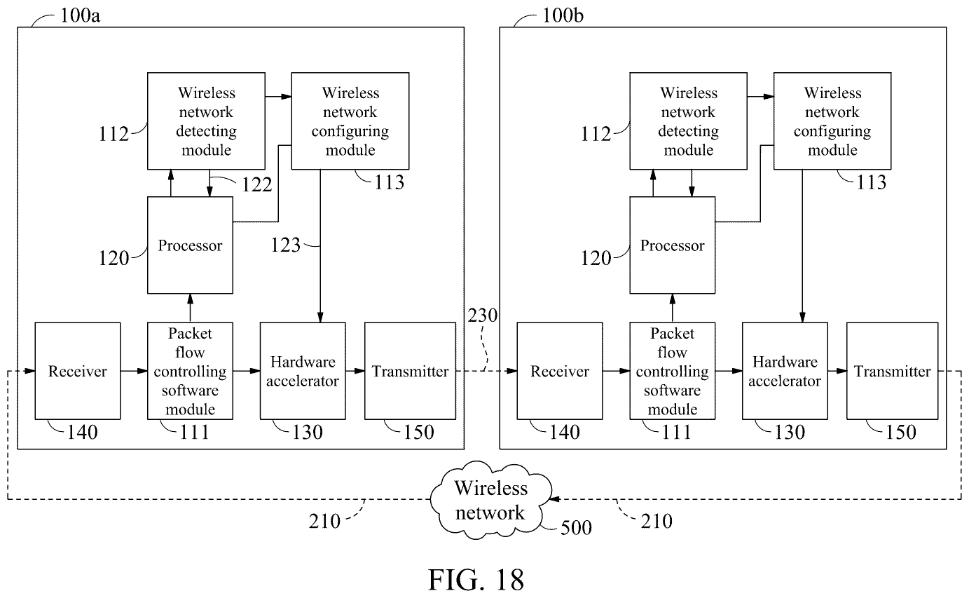

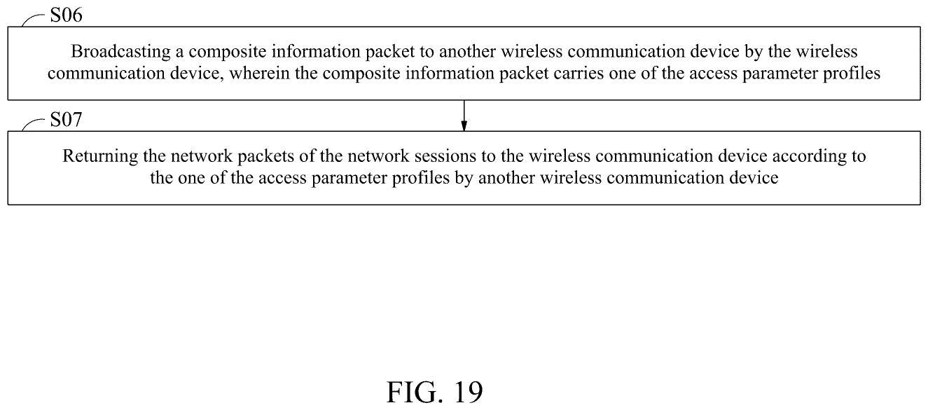

Please refer to FIG. 18 and FIG. 19. FIG. 18 is a schematic view of the wireless communication device 100a of the present disclosure communicating with another wireless communication device 100b. FIG. 19 is a flow chart of Step S06 of broadcasting a composite information packet 230 and Step S07 of returning the network sessions 210 of the differentiated quality of service providing method 400 in FIG. 4. The wireless communication device 100a is signally connected to the wireless communication device 100b via a wireless network 500, and the wireless communication devices 100a, 100b have the same internal component configuration. Specifically, the wireless communication device 100a can be a wireless access point of an upstream port, and the wireless communication device 100b can be a client device of a downstream port.

In some embodiments, the differentiated quality of service providing method 400 can further include Steps S06, S07. Step S06 involves broadcasting a composite information packet 230 to another wireless communication device 100b by the wireless communication device 100a, wherein the composite information packet 230 carries one of the access parameter profiles. Step S07 involves returning the network packets of the network sessions 210 to the wireless communication device 100a according to the one of the access parameter profiles by another wireless communication device 100b. In detail, when the wireless communication device 100a initially performs data transmission with the wireless communication device 100b, the processor 120 of the wireless communication device 100a dynamically detects the wireless network 500 through the wireless network detecting module 112 to obtain the congestion percentage 122. The processor 120 selects the access parameter profile 1131 according to the congestion percentage 122 and integrates it into the composite information packet 230, which is then transmitted to the wireless communication device 100b by broadcasting. Therefore, the adjustments of the EDCA parameter in the differentiated priority list 123 of the wireless communication device 100a can be applied to the transmission queue of the wireless communication device 100b, such that the returned network packets also benefit from the effect of differentiated quality of service.

In summary, the wireless communication device and the differentiated quality of service providing method of the present disclosure have the following advantages. First, by dynamically detecting the wireless network to calculate the congestion percentage, and then configuring, according to the congestion percentage, the access parameter groups corresponding to different priority levels in the differentiated priority list, higher-priority levels are allocated greater bandwidth, thereby achieving the differentiated QoS effect. Second, through the machine learning algorithm, not only can the priority level to which each network session belongs be automatically identified, but the application type corresponding to each priority level can also be determined through the application type lookup table. Third, the QoS of other network services can be configured, thereby realizing transmission mechanisms of queuing, dequeuing, forwarding and routing with different priority levels across multiple network services.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A wireless communication device, which is configured to receive a plurality of network sessions from a wireless network, and the wireless communication device comprising:
a memory storing a wireless network detecting module and a wireless network configuring module, wherein the wireless network detecting module comprises a congestion detection algorithm; and
a processor connected to the memory and configured to implement a differentiated quality of service providing method comprising:
executing the wireless network detecting module to analyze a plurality of network packets of the network sessions and classify the network sessions into a plurality of priority levels by the processor;
executing the wireless network detecting module to detect the wireless network to obtain a network status information and calculate the network status information according to the congestion detection algorithm to generate a congestion percentage by the processor; and
executing the wireless network configuring module to establish a differentiated priority list based on the priority levels and configure a plurality of access parameter groups corresponding to the priority levels in the differentiated priority list according to the congestion percentage by the processor;
wherein the wireless communication device forwards the network packets of the network sessions according to the access parameter groups to provide a quality of service for the network sessions.

2. The wireless communication device of claim 1, wherein,
the wireless network detecting module extracts a plurality of packet characteristic information and a plurality of session identification information from the network packets of the network sessions;
the wireless network detecting module further comprises a packet flow matrix and compares the packet characteristic information with the packet flow matrix to determine the priority levels corresponding to the network sessions; and
the wireless network detecting module respectively labels the network sessions with a plurality of identification numbers according to the session identification information and classifies the network sessions into the priority levels according to the identification numbers, and the identification numbers are different from each other.

3. The wireless communication device of claim 2, wherein,
each of the packet characteristic information comprises at least one of a packet length information and a packet time information; and
each of the session identification information comprises a communication protocol, a source address, a source port, a destination address and a destination port.

4. The wireless communication device of claim 1, wherein,
the wireless network detecting module calculates the network status information according to the congestion detection algorithm to obtain a channel utilization rate, a packet loss rate, a queue occupancy rate and a flow delay rate; and
the wireless network detecting module performs a weighted calculation on the channel utilization rate, the packet loss rate, the queue occupancy rate and the flow delay rate to generate the congestion percentage.

5. The wireless communication device of claim 1, wherein,
the wireless network configuring module comprises a plurality of access parameter profiles corresponding to a plurality of congestion levels; and
the wireless network configuring module compares the congestion percentage with the congestion levels to select one of the access parameter profiles, and adjusts the access parameter groups corresponding to the priority levels in the differentiated priority list based on the one of the access parameter profiles.

6. The wireless communication device of claim 5, wherein the wireless communication device broadcasts a composite information packet to another wireless communication device, and the composite information packet carries the one of the access parameter profiles.

7. The wireless communication device of claim 1, wherein each of the access parameter groups comprises an arbitration interframe space, a minimum contention window, a maximum contention window, and a transmission opportunity.

8. The wireless communication device of claim 1, wherein,
the memory further stores a packet flow controlling module, each of the network sessions comprises a first packet group and a second packet group; and
the processor executes the packet flow controlling module to determine whether the first packet group has been classified into one of the priority levels;
wherein when the first packet group has been classified into the one of the priority levels, the packet flow controlling module transmits the second packet group to the processor, and the processor transmits the second packet group according to the differentiated priority list;
wherein when the first packet group has not been classified into any one of the priority levels, the packet flow controlling module transmits the first packet group to the processor.

9. The wireless communication device of claim 1, further comprising:
a hardware accelerator connected to the processor;
wherein the processor executes the wireless network configuring module to write the differentiated priority list into the hardware accelerator, and the hardware accelerator transmits the network packets of the network sessions according to the differentiated priority list.

10. The wireless communication device of claim 9, wherein,
the memory further stores a packet flow controlling module, each of the network sessions comprises a first packet group and a second packet group; and
the processor executes the packet flow controlling module to determine whether the first packet group has been classified into one of the priority levels;
wherein when the first packet group has been classified into the one of the priority levels, the packet flow controlling module transmits the second packet group to the hardware accelerator, and the hardware accelerator transmits the second packet group according to the differentiated priority list;
wherein when the first packet group has not been classified into any one of the priority levels, the packet flow controlling module transmits the first packet group to the processor.

11. A differentiated quality of service providing method, comprising:
receiving a plurality of network sessions from a wireless network by a wireless communication device, wherein the wireless communication device comprises a memory and a processor, the memory stores a wireless network detecting module and a wireless network configuring module, and the wireless network detecting module comprises a congestion detection algorithm;
executing the wireless network detecting module to analyze a plurality of network packets of the network sessions and classify the network sessions into a plurality of priority levels by the processor;
executing the wireless network detecting module to detect the wireless network to obtain a network status information and calculate the network status information according to the congestion detection algorithm to generate a congestion percentage by the processor;
executing the wireless network configuring module to establish a differentiated priority list based on the priority levels and configure a plurality of access parameter groups corresponding to the priority levels in the differentiated priority list according to the congestion percentage by the processor; and
forwarding the network packets of the network sessions according to the access parameter groups to provide a quality of service for the network sessions by the wireless communication device.

12. The differentiated quality of service providing method of claim 11, wherein the wireless network detecting module further comprises a packet flow matrix, and a step of classifying the network sessions into the priority levels comprises:
executing the wireless network detecting module to extract a plurality of packet characteristic information and a plurality of session identification information from the network packets of the network sessions by the processor;
executing the wireless network detecting module to compare the packet characteristic information with the packet flow matrix to determine the priority levels corresponding to the network sessions by the processor; and
executing the wireless network detecting module to respectively label the network sessions with a plurality of identification numbers according to the session identification information and classify the network sessions into the priority levels according to the identification numbers by the processor, wherein the identification numbers are different from each other.

13. The differentiated quality of service providing method of claim 12, wherein,
each of the packet characteristic information comprises at least one of a packet length information and a packet time information; and
each of the session identification information comprises a communication protocol, a source address, a source port, a destination address and a destination port.

14. The differentiated quality of service providing method of claim 11, wherein a step of generating the congestion percentage comprises:
executing the wireless network detecting module to calculate the network status information according to the congestion detection algorithm to obtain a channel utilization rate, a packet loss rate, a queue occupancy rate and a flow delay rate by the processor; and
executing the wireless network detecting module to perform a weighted calculation on the channel utilization rate, the packet loss rate, the queue occupancy rate and the flow delay rate to generate the congestion percentage by the processor.

15. The differentiated quality of service providing method of claim 11, wherein the wireless network configuring module comprises a plurality of access parameter profiles corresponding to a plurality of congestion levels, and a step of configuring the access parameter groups corresponding to the priority levels in the differentiated priority list according to the congestion percentage comprises:
executing the wireless network configuring module to compare the congestion percentage with the congestion levels to select one of the access parameter profiles, and adjust the access parameter groups corresponding to the priority levels in the differentiated priority list based on the one of the access parameter profiles by the processor.

16. The differentiated quality of service providing method of claim 15, further comprising:
broadcasting a composite information packet to another wireless communication device by the wireless communication device, wherein the composite information packet carries the one of the access parameter profiles; and
returning the network packets of the network sessions to the wireless communication device according to the one of the access parameter profiles by the another wireless communication device.

17. The differentiated quality of service providing method of claim 11, wherein each of the access parameter groups comprises an arbitration interframe space, a minimum contention window, a maximum contention window, and a transmission opportunity.

18. The differentiated quality of service providing method of claim 11, wherein the memory further stores a packet flow controlling module, each of the network sessions comprises a first packet group and a second packet group, and a step of receiving the network sessions from the wireless network comprises:
executing the packet flow controlling module to determine whether the first packet group has been classified into one of the priority levels by the processor;
wherein when the first packet group has been classified into the one of the priority levels, the packet flow controlling module transmits the second packet group to the processor, and the processor transmits the second packet group according to the differentiated priority list;
wherein when the first packet group has not been classified into any one of the priority levels, the packet flow controlling module transmits the first packet group to the processor.

19. The differentiated quality of service providing method of claim 11, wherein the wireless communication device further comprises a hardware accelerator, and a step of forwarding the network packets of the network sessions according to the access parameter groups comprises:
executing the wireless network configuring module to write the differentiated priority list into the hardware accelerator by the processor; and
transmitting the network packets of the network sessions according to the differentiated priority list by the hardware accelerator.

20. The differentiated quality of service providing method of claim 19, wherein the memory further stores a packet flow controlling module, each of the network sessions comprises a first packet group and a second packet group, and a step of receiving the network sessions from the wireless network comprises:
executing the packet flow controlling module to determine whether the first packet group has been classified into one of the priority levels by the processor;
wherein when the first packet group has been classified into the one of the priority levels, the packet flow controlling module transmits the second packet group to the hardware accelerator, and the hardware accelerator transmits the second packet group according to the differentiated priority list;
wherein when the first packet group has not been classified into any one of the priority levels, the packet flow controlling module transmits the first packet group to the processor.
